(19) United States
(12) Patent Application Publication
(10) Pub. No.: US 2021/0391991 A1
(43) Pub. Date: Dec. 16, 2021

(54) LINKING IDENTITIES IN A DISTRIBUTED DATABASE

(71) Applicant: SIEMENS AKTIENGESELLSCHAFT, München (DE)

(72) Inventors: Hans Aschauer, München (DE); Markus Dichtl, Neu-Ulm (DE); Ingo Wenda, Augsburg (DE); Andreas Bogner, München (DE)

(21) Appl. No.: 17/284,461

(22) PCT Filed: Oct. 2, 2019
(86) PCT No.: PCT/EP2019/076721

§ 371 Date: Apr. 10, 2021

(30) Foreign Application Priority Data
Oct. 10, 2018 (EP) 18199653.9

(51) Int. Cl. H04L 9/32; H04L 9/08

(52) U.S. Cl. CPC H04L 9/321; H04L 2209/38; H04L 9/3247; H04L 9/0825

(57) ABSTRACT

For a user of a distributed database (100) which has a first identity, transaction data (120) of a transaction is stored in the distributed database (100). The transaction links the first identity to a second identity.

This application is the National Stage of International Application No. PCT/EP2019/076721, filed Oct. 2, 2019, which claims the benefit of European Patent Application No. EP 18199653.9, filed Oct. 10, 2018. The entire contents of these documents are hereby incorporated herein by reference.

### BACKGROUND

The present disclosure concerns methods, apparatuses, and computer programs for providing or operating a distributed database.

The prior art discloses the document U.S. Pat. No. 8,531,247 B2, the document U.S. Pat. No. 8,892,616 B2, the document U.S. Pat. No. 8,300,811 B2, the document U.S. Pat. No. 9,147,088 B2, the document U.S. Pat. No. 9,584,311 B2, the document EP 2976707 B1, the document EP 2 605 445 B1, the document EP 2 870 565 A1, the document EP 2 891 102 A1, the document WO 2017137256 A1, the document EP 2870565 B1, EP 2891266 B1, the document EP 2961091 A1, the document EP 2961093 A1, the document EP 3028140 B1, the document EP 2930610 B1, the document EP 2940620 B1, the document EP 2899714 A1, the document EP 2981926 A0, the document EP 3125492 B1, the document EP 17195125, the document EP 17211075, the document EP 18178316, the document EP 18156084, the document EP 18151345, the document EP 18167702, the document EP 18153594, the document EP 18162050, the document EP 18178498, the document EP 18152117, the document EP 18150133, the document EP 18169145, the document EP 17210647, the document EP 18150146, the document EP 18167486, the document EP 18168670, the document EP 18162049, the document EP 17203819, the document EP 18157168, the document EP 18169421, the document EP 17210253, the document EP 17205224, the document EP 18169269, the document EP 18169254, the document EP 17210288, the document EP 18153025, the document EP 17200614, the document EP 18156308, the document EP 17201758, the document EP 18156511, the document EP 18159485, the document EP 17203573, the document EP 17175275, the document EP 17186826, the document WO 2018069271 A1, the document PCT/EP2017/082508, the document EP 17179823, the document WO 2017050348 A1, the document WO 2018068965 A1 and the document U.S. Pat. No. 8,843,761 B2.

A distributed database, sometimes also referred to as a “distributed ledger”, typically uses cryptographic methods and consensus methods in order to protect information stored in the distributed database against manipulation. Such a distributed database may be implemented as blockchain, for example. The technology of blockchains, or distributed ledgers, is currently used in a growing variety of areas of application. Besides applications for decentralized payment systems (e.g., Bitcoin), new opportunities for application are being developed (e.g., in the financial industry). For example, transactions between companies may therefore be performed in a manner protected against manipulation without a broker or clearing house. This allows new business models without a trusted broker and reduces transaction costs, and new digital services may be provided flexibly without needing to set up an infrastructure that is set up specifically for that purpose and relationships of trust. A transaction data record (e.g., a transaction for short) protected by a blockchain includes, for example, program code, which may also be referred to as a “smart contract”.

To safeguard transactions in the distributed database, it is known practice to link the identity of a user to a public cryptographic key. Signature using a private cryptographic key, which is normally accessible only to the user, associated with this public key allows the user to demonstrate that a transaction in the distributed database was actually initiated by the user.

The public keys of the users in a distributed database are typically generated by the users themselves without further metadata and are therefore anonymous, or pseudonymous. However, some applications may require the identity linked to a transaction to be known. An industrially relevant example that will be mentioned is, for example, that not all goods may be exported to all countries, which provides that before an agreement is signed, it is necessary for the identity of the party to the agreement to be examined. Depending on the application scenario, it may thus be necessary to provide that a public key is assigned to a specific natural or legal person. This also, for example, allows claims to be asserted against this natural or legal person using judicial means.

To authenticate a cryptographic public key (e.g., a public part of an asymmetric key pair), it is known practice to use a public key infrastructure (PKI), which involves the identity linked to the cryptographic public key (e.g., a natural or legal person) being confirmed by a trusted body. This confirmation of an identity may be effected, for example, by a certificate that is digitally signed by the trusted body. This requires the trusted body to provide that the linked identity is authentic (e.g., based on an identity document). However, this task may also be delegated by the trusted body to a further body, which is typically referred to as registration authority (RA). The RA merely checks the asserted authenticity of the identity and hands over the result of a corresponding check to a body referred to as certification authority (CA), which, if the authenticity was confirmed, then confirms the authenticity of the identity by signing the certificate. However, in connection with a distributed database, the illustrated use of a PKI leads to a comparatively high level of complexity, since, for example, not only the distributed database but also functions for managing certificates are to be provided.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, technologies that allow efficient use of a distributed database with authenticated users are provided.

According to one exemplary embodiment, a first apparatus for providing a distributed database is disclosed. The apparatus may implement a node of a distributed database system, for example. The first apparatus is configured to, for a user of the distributed database that has a first identity, store transaction data of a transaction in the distributed database, where the transaction links the first identity to a second identity.

The effect that may be achieved by this is that the first identity may be linked to the second identity in an efficient and manipulation-proof manner.

The first identity includes a public cryptographic key that is able to be used for signing a transaction in the distributed database. When such a transaction is initiated, the transaction data of this transaction may include the public cryptographic key, a hash value of the public cryptographic key, and/or an identifier of the public cryptographic key.

In one exemplary embodiment of the first apparatus, the transaction for linking the identities is able to be initiated exclusively by one or more users of the distributed database that are categorized as trusted. This allows, for example, the authenticity of the second identity to be provided.

According to one exemplary embodiment, the first apparatus is also configured to store transaction data of at least one further transaction in the distributed database, where the further transaction cancels the linking of the first identity of the user to the second identity of the user. The further transaction may also be able to be initiated exclusively by one or more users of the distributed database that are categorized as trusted (e.g., by the same user that initiated the transaction for linking the identities). This allows the previously produced linking of the first identity and the second identity to be cancelled again in an efficient and manipulation-proof manner.

Cancellation of the linking of the two identities again may be necessary or appropriate for various reasons. In some cases, the reason may be that a legal relationship was terminated. This may be the case, for example, when an employee leaves a company, or when a motor vehicle is sold. When a motor vehicle is sold, it should not be possible, for example, for the motor vehicle to continue to initiate transactions that are chargeable to a former owner. Cancellation of linkings of the two identities again may also be necessary for security reasons (e.g., if key material was compromised).

In one exemplary embodiment of the first apparatus, the user is identifiable outside the distributed database by the second identity. An anonymous or pseudonymous use of the first identity may therefore be avoided.

In one exemplary embodiment of the first apparatus, the second identity includes one or more pieces of information that identify the user as a natural person, a legal person, an organization, a machine, or a physical object. The information may include, for example, a name (e.g., personal name, organization name, device name, product name, or manufacturer name). Additionally, such information may also include other identification information (e.g., a product number) or address data. The user may therefore be reliably identified by the second identity. Identification as a natural person or a legal person may also allow legal claims to be asserted, for example. This may be advantageous, for example, if the first identity is used in a business process between the user and a further user (e.g., in order to sign an applicable transaction in the distributed database).

According to another exemplary embodiment, a second apparatus for providing a distributed database is disclosed. The apparatus may, for example, implement a node of a distributed database system or provide access to one or more nodes of a distributed database system. The second apparatus is configured to, for a user of the distributed database that has a first identity, examine a second identity. The second apparatus is also configured to initiate a transaction in the distributed database that links the first identity to the second identity.

The first identity includes a public cryptographic key that is able to be used by the user for signing a transaction in the distributed database.

The examining of the second identity may include a confirmation of the authenticity of the second identity by a trusted body (e.g., a registration authority (RA)). The second apparatus may use the distributed database to interact with the trusted body or may be implemented as part of the trusted body.

In one exemplary embodiment of the second apparatus, the user is identifiable outside the distributed database by the second identity. An anonymous or pseudonymous use of the first identity may therefore be avoided.

In one exemplary embodiment of the second apparatus, the second identity includes one or more pieces of information that identify the user as a natural person, a legal person, a machine, or a physical object. The information may include, for example, a name (e.g., a personal name, an organization name, a device name, a product name, or a manufacturer name). Additionally, such information may also include other identification information (e.g., a product number) or address data. The user may therefore be reliably identified by the second identity. Identification as a natural person or a legal person may also allow legal claims to be asserted, for example. This may be advantageous, for example, if the first identity is used in a business process between the user and a further user (e.g., in order to sign an applicable transaction in the distributed database).

In one exemplary embodiment of the second apparatus, the transaction for linking the identities is able to be initiated exclusively by one or more users of the distributed database that are categorized as trusted. This allows, for example, the authenticity of the second identity to be provided.

According to one exemplary embodiment, the second apparatus is also configured to initiate a further transaction in the distributed database, where the further transaction cancels the linking of the first identity to the second identity. The further transaction may likewise be able to be initiated exclusively by one or more users of the distributed database that are categorized as trusted (e.g., by the same user that initiated the transaction for linking the identities). This allows the previously produced linking of the first identify and the second identity to be cancelled again in an efficient and manipulation-proof manner.

According to another exemplary embodiment, a first method is provided. The first method includes, for a user of a distributed database that has a first identity, storing transaction data of a transaction in the distributed database, where the transaction links the first identity to a second identity.

The first identity of the user includes a public cryptographic key that is able to be used for signing a transaction in the distributed database. When such a transaction is initiated, the transaction data of this transaction may include the public cryptographic key, a hash value of the public cryptographic key, and/or an identifier of the public cryptographic key.

In one exemplary embodiment of the first method, the transaction for linking the identities is able to be initiated exclusively by one or more users of the distributed database that are categorized as trusted. This allows, for example, the authenticity of the second identity to be provided.

In one exemplary embodiment of the first method, the user is identifiable outside the distributed database by the second identity.

In one exemplary embodiment of the first method, the second identity includes one or more pieces of information that identify the user as a natural person, a legal person, a machine, or a physical object. The information may include, for example, a name (e.g., a personal name, an organization name, a device name, a product name, or a manufacturer name). Additionally, such information may also include other identification information (e.g., a product number) or address data.

According to one exemplary embodiment, the first method also includes storing further transaction data of a further transaction in the distributed database, where the further transaction cancels the linking of the first identity to the second identity.

The further transaction may likewise be able to be initiated exclusively by one or more users of the distributed database that are categorized as trusted (e.g., by the same user that initiated the transaction for linking the identities).

According to another exemplary embodiment, a second method is provided. The second method includes, for a user of a distributed database that has a first identity, examining a second identity, and initiating a transaction in the distributed database that links the first identity to the second identity.

The first identity of the user includes a public cryptographic key used for signing the first transaction. The first transaction data may include the public cryptographic key, a hash value of the public cryptographic key, and/or an identifier of the public cryptographic key.

The examining of the second identity may include a confirmation of the authenticity of the second identity by a trusted body (e.g., a registration authority (RA)).

In one exemplary embodiment of the second method, the user is identifiable outside the distributed database by the second identity.

In one exemplary embodiment of the second method, the second identity includes one or more pieces of information that identify the user as a natural person, a legal person, an organization, a machine, or a physical object. The information may include, for example, a name (e.g., a personal name, an organization name, a device name, a product name, or manufacturer name). Additionally, such information may also include other identification information (e.g., a product number) or address data.

In one exemplary embodiment of the second method, the transaction for linking the identities is able to be initiated exclusively by one or more users of the distributed database that are categorized as trusted.

According to one exemplary embodiment, the second method also includes initiating a further transaction in the distributed database, where the further transaction cancels the linking of the first identity to the second identity.

The further transaction may likewise be able to be initiated exclusively by one or more users of the distributed database that are categorized as trusted (e.g., by the same user that initiated the transaction for linking the identities).

According to another exemplary embodiment, a computer program or computer program product (e.g., in the form of a machine-readable data medium such as a CD, a DVD, a magnetic tape, a hard disk or a USB stick) that includes program code that, when executed by one or more processors of a programmable apparatus, causes the apparatus to carry out the first method and/or second method according to one of the exemplary embodiments cited above is provided. The program code may be a source code (e.g., in a programming language such as C or C++) that is still to be compiled and linked or interpreted, or an executable program code.

In the case of the exemplary embodiments cited, the user may be an entity for which information is stored in the distributed database. Examples of such an entity are: a natural person, a legal person, a machine (e.g., an IoT (Internet of Things) device), or a physical object (e.g., a product).

In the case of the exemplary embodiments cited, the use of the distributed database, which may be implemented as blockchain, for example, allows the linking of the first identity and the second identity to be stored in an efficient manner with high integrity and accessible to other users of the distributed database, without this requiring a separate PKI infrastructure.

The distributed database may be used to store the transaction data in different nodes of a distributed database system, which may be physically separate from one another. The nodes of the distributed database system may compare the transaction data against one another; as a result of this, it is provided that the transaction data is stored redundantly in different nodes of the distributed database. Manipulation of a single node or a number of nodes of the distributed database may therefore be reliably detected by the comparison between the nodes. Any divergence in the transaction data between two nodes that is detected by the comparison may also be corrected by the comparison.

### BRIEF DESCRIPTION OF THE DRAWINGS

FIG. 1 schematically illustrates a distributed database according to an exemplary embodiment.

FIG. 2 schematically shows a distributed database system according to an exemplary embodiment.

FIG. 3 shows a flowchart to illustrate a method according to an exemplary embodiment.

FIG. 4 shows a flowchart to illustrate another method according to an exemplary embodiment.

### DETAILED DESCRIPTION

In the description of exemplary embodiments that follows, the accompanying drawings may be regarded as schematic, and the drawings and depicted elements are not necessarily to scale. Rather, the drawings are intended to illustrate functions and interaction of elements and components. In this instance, any connection or coupling of depicted functional blocks, apparatuses, components, or other physical or functional elements may also be implemented by an indirect connection or coupling (e.g., via one or more intermediate elements). A connection between components may be implemented by a wired and/or wireless data connection, for example. Functional blocks may be implemented by hardware, firmware, and/or software.

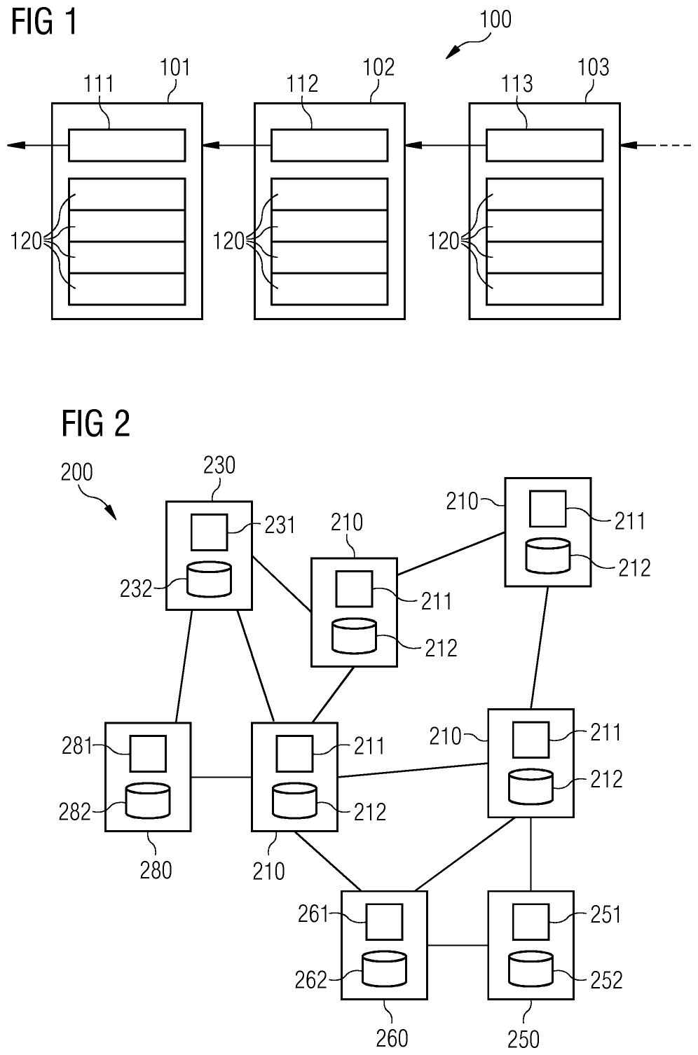

FIG. 1 schematically illustrates a distributed database 100. It is subsequently assumed that the distributed database 100 is implemented as blockchain. However, other implementations of the distributed database 100 are likewise possible.

The distributed database 100 includes multiple data blocks 101-103 that are linked in the form of a chain or succession of data blocks 101-103. Each data block 101-103 has a checksum 111-113 that represents a hash value, for example. The checksum 111-113 is determined based on the respectively preceding data block within the succession of data blocks 101-103. By way of example, the checksum 112 of the data block 102 is formed based on the data block 101; this is depicted by the applicable arrow in FIG. 1. The checksum 112 or 113 of the data block 102 or 103 may be, for example, a hash value that is calculated based on the data stored in the respectively preceding data block 101 or 102. This allows modification (e.g., unauthorized modification) of the data block 101 or 102 to be detected by virtue of the data block 101 or 102 being compared with the checksum 112 or 113.

Each data block 101-103 may store transactions 120. Each transaction 120 may include applicable data or refer to applicable data by virtue of an appropriate reference, an appropriate piece of additional information, or an appropriate checksum, etc. being stored. The data pertaining to a specific transaction 120 that is stored in the distributed database 100 is also referred to as transaction data herein.

The transaction data stored in the data blocks 101-103 may include, for example, data pertaining to an agreement between two or more users of the distributed database 100.

The transactions 120 stored in the data blocks 101, 102, 103 may include, for example, program code realized as a smart contract. This program code may include information concerning whether a transaction 120 is permitted. This allows, for example, various business processes such as agreements or the like to be organized by a common distributed database structure in a flexible and manipulation-proof manner. To safeguard the content of the respective data blocks 101, 102, 103, it is possible to use, for example, a hash tree, a Merkle tree, or a Patricia tree.

FIG. 2 shows a distributed database system 200 that may be used for implementing the distributed database 100. In the depicted example, the distributed database system includes multiple nodes 210, 230, 250, 260, 280 that may perform transactions in the distributed database 100. As depicted, each of the nodes 210, 230, 250, 260, 280 has at least one processor 211, 231, 251, 261, 281 and a memory 212, 232, 252, 262, 282. The at least one processor 211, 231, 251, 261, 281 may be used to execute program code stored in the memory 212, 232, 252, 262, 282. This may be, for example, program code of the transactions of the distributed database 100 (e.g., smart contract program code). At least some of the nodes 210, 230, 250, 260, 280 store the transaction data 120 of the distributed database 100, as explained above, and participate in a consensus process in order to compare the stored transaction data 120 against one another and thus to protect the stored transaction data 120 against manipulation.

The nodes 210, 230, 250, 260, 280 may each be assigned to a user of the distributed database 100 and accordingly also be referred to as user nodes or subscriber nodes. Each user of the distributed database has a first assigned identity. This first identity may be used, for example, to sign transactions initiated by the user. The first identity may therefore correspond to a blockchain identity of the user. The first identity includes, for example, a public cryptographic key. The public cryptographic key may be stored in the distributed database as part of the transaction data 120. Additionally, it is also possible to store a reference to the public cryptographic key in the transaction data 120 (e.g., in the form of a hash value or another type of identifier).

In the case of the distributed database system 200, the node 250 is assigned to a user categorized as trusted. As explained in more detail below, this allows the node 250 to be used to initiate specific types of transactions that are not available to other users of the distributed database 100. These are used, for example, to link the first identity of a user of the distributed database 100 to a second identity. In the example in FIG. 2, it is assumed that for a user assigned to the node 230, the first identity is intended to be linked to a second identity. The user of the node 230 initiates an appropriate transaction in the distributed database 100. The node 230 does not have to be a subscriber of the distributed database 100 (e.g., it is not necessary for the node 230 itself to store transaction data of the distributed database 100 or to participate in the consensus method of the distributed database 100).

The second identity may be, for example, information that identifies the user outside the distributed database as a natural person, a legal person, an organization, a machine, or a physical object. The second identity may allow a unique identification of the user. The second identity is therefore able to be used to identify the respective user outside the distributed database 100. In other words, the first identity of the user may be used anonymously or pseudonymously, whereas the linking of the first identity and the second identity cancels the anonymous or pseudonymous nature of the first identity. In the depicted example, the linking is performed by virtue of a data structure referred to as a certificate being stored in the distributed database 100 (e.g., as part of the transaction data 120). The certificate may be stored in the distributed database 100, for example, as the state of a smart contract.

The node 250 that initiates the linking may therefore also be referred to as a “certification authority” (CA), or a CA node. As a result of the linking being stored in the distributed database 100 and as a result of the applicable transaction being initiated only by the CA node 250, manipulations of the linking may be reliably avoided. Additionally, there may also be provision for the CA node 250 to initiate transactions in order to cancel an already existing linking of the first identity and the second identity of a user again. This may involve a certificate already stored in the distributed database 100 being marked as revoked or being deleted.

In the depicted example, the CA node 250 uses the distributed database 100 to interact with a further node 260, which assists the CA node 250 in an examination of the second identity of the user. For example, the further node 260 may confirm the authenticity or legality of the second identity to the CA node. This may be done in a similar manner to that in the case of a “registration authority” (RA) of a conventional PKI system. The node 260 may therefore also be referred to as an RA node. In the depicted example, the RA node 260 uses a transaction in the distributed database 100 to confirm the authenticity or legality of the second identity. As already mentioned, the at least one processor 261 of the RA node may be used to execute program code stored in the memory 262. This may be, for example, program code in order to implement typical RA functions. The RA node 260 does not have to be a subscriber of the distributed database 100 (e.g., is not necessary for the RA node 260 itself to store transaction data of the distributed database 100 or to participate in the consensus method of the distributed database 100).

As depicted, there may also be provision in the distributed database system 200 for one or more access nodes 280 via which queries to the distributed database 100 are possible. By way of example, the access node 280 may transmit a request pertaining to a specific transaction to the distributed database 100 and then receive a response indicating whether or not the transaction is permitted and furthermore indicating the second identity of the user that initiated the transaction. The node 280 may also be used, for example, to make a request to the distributed database 100 to verify the second identity of the user. The access node 280 does not have to be a subscriber of the distributed database 100 (e.g., it is not necessary for the access node 280 itself to store transaction data of the distributed database 100 or to participate in the consensus method of the distributed database 100).

Although only one CA node 250 and one RA node 260 are depicted in FIG. 2, in some implementations, there may also be provision for multiple CA nodes 250 and/or multiple RA nodes 260. Similarly, there may be provision for multiple nodes 230 via which a user may initiate a linking of the first identity of the user and a second identity. Additionally, there may also be provision for any number of access nodes 280, or separate access nodes that are not subscribers of the distributed database 100 may be dispensed with completely.

In one illustrative implementation, a smart contract program code for implementing the functionalities explained above may have the following functions: a “requestCertificate” function; an “approveEntity” function; a “certifyEntity” function; a “revokeCertificate” function; a “deleteCertificate” function; and a “verifyEntity” function.

These functions may each be implemented by one or more smart contract processes, for example.

The fundamental data structure may be defined by a certificate, as shown in Table 1.

TABLE 1

struct Certificate {

| | |
|---|---|
| address | blockchainId; |
| string | commonName; |
| uint256 | startDate; |
| uint256 | endDate; |
| State | state; |

}
struct Certificate {

| | |
|---|---|
| address | blockchainId; |
| string | commonName; |
| uint256 | startDate; |
| uint256 | endDate; |
| State | state; |

}

Here, “blockchainId” represents the address in the blockchain that corresponds to the aforementioned first identity, “commonName” represents the second identity that is intended to be linked to the first identity from the blockchain, and “startDate” and “endDate” define the start and end of a validity period of the certificate. A state of the certificate is indicated by “state” and may assume the values “Requested”, “Approved”, “Certified”, and “Revoked”, which are normally processed in succession at least up to “Certified”.

The data structure used for collecting the certificates in the case of the smart contract language “Solidity” may be a mapping referred to as “certificates”. A mapping in Solidity is a data structure in which arbitrary indices may be used to access other data, each key value present in the mapping having precisely one assigned datum. However, comparable data structures are also available in other languages and may be used. As such, the languages Python and Smalltalk cite a data structure “Dictionary” that is comparable with the mapping of Solidity, Perl cites “Hash”, and Java cites “Hashtable”, which refers to the technique of hash tables used for implementing it. The languages JavaScript and Wolfram Language refer to a comparable data structure as “Associative Array”. In the “certificates” mapping, the keys are blockchain addresses and the values are certificates. Because mappings in Solidity do not allow iteration, it is also possible to use lists of addresses for which certificates were requested, or set to “Approved”.

First, a user may request a certificate in the blockchain by calling the function “requestCertificate”, additionally providing the second identity with which the user wishes to be certified as a parameter. The smart contract first checks whether there is already a certificate for the calling blockchain address. If this is the case, a new certificate cannot be requested.

The new certificate is entered with the status “Requested” in the “certificates” mapping at the blockchain address of the requester, and this address is also appended to the list of requested certificates. The validity period of the certificate is stipulated as one year from issue in the depicted example.

The “approveEntity” function may be used only by the RA. In practical applications, the RA may also have tasks beyond the functionality realized in the depicted example. These tasks may sometimes also include processes that need to be performed manually (e.g., if the authentication of a natural person requires an identity document of the person to be presented). The RA processes all of the entries that are in the list of requested certificates.

If the RA confirms the identity and finds that a certificate may be issued, the RA prompts the “approveEntity” function to be used to increase the status of the certificate in the “certificates” mapping to “Approved”. The address of the requester is removed from the list of requested certificates and appended to the “approvedCertificates” list.

The “certifyEntity” function may be used only by the CA. The CA processes all of the entries that are in the “approvedCertificates” list. The CA sets the status of the applicable certificate in the “certificates” mapping to “Certified” and removes the address from the “approvedCertificates” list.

If any user of the blockchain now wishes to check whether another identity is actually associated with a specific blockchain address, the user calls the “verifyEntity” function, which receives the blockchain address and the other identity coded as a string as parameters. The function examines whether an entry with the status “Certified” and with the indicated string exists at the indicated address in “certificates”. If this is the case and if the certificate has not yet expired, the response that is returned is “true”; in all other cases, the response that is output is “false”.

Additionally, there is provision in the depicted example for functions for revoking or deleting certificates. As such, the CA may use the “revokeCertificate” function to set the status of a certificate in the “certificates” mapping to “Revoked” in order to revoke the certificate, or may use the “deleteCertificate” function to delete a certificate from the “certificates” mapping.

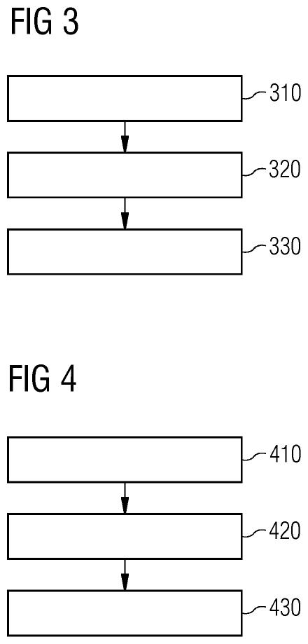

FIG. 3 shows a flowchart to illustrate a method that may be used to implement the depicted concepts in a node 210, 230, 250, 260, 280 of the distributed database system 200. The method may be implemented, for example, by virtue of program code stored in a memory of the node 210, 230, 250, 260, 280 being executed by one or more processors 211, 231, 251, 261, 281 of the node 210, 230, 250, 260, 280.

In block 310, the node 210, 230, 250, 260, 280 may optionally store first transaction data 120 of a first transaction in the distributed database 100. The first transaction is initiated by a user of the distributed database 100. This may be a user assigned to the node 210, 230, 250, 260, 280 or another user of the distributed database. The user has an assigned first identity. The transaction may be linked to a first identity. The first transaction may be a request from the user to link the first identity to a second identity (e.g., by calling the aforementioned “requestCertificate” function).

The first identity includes a public cryptographic key of the user that is used for signing the first transaction. For example, the first identity may be a public cryptographic key of the user that is used for signing the first transaction. The first transaction data may include the public cryptographic key, a hash value of the public cryptographic key, and/or another identifier of the public cryptographic key.

In block 320, the node 210, 230, 250, 260, 280 stores second transaction data 120 of a second transaction in the distributed database 100. The second transaction links the first identity to a second identity. This may involve, for example, an applicable certificate that assigns the first identity to the second identity being stored in the distributed database 100. The second transaction may be, for example, initiated by a user of the distributed database 100 that is categorized as trusted (e.g., by the aforementioned CA node 250).

The user may be identifiable outside the distributed database by the second identity. An anonymous or pseudonymous nature of the first identity may therefore be cancelled by the linking. The second identity may include, for example, one or more pieces of information that identify the user as a natural person, a legal person, an organization, a machine, or a physical object (e.g., in the form of a name or an address).

In block 330, the node 210, 230, 250, 260, 280 may optionally also store third transaction data 120 of a third transaction in the distributed database 100. The third transaction causes the linking of the first identity of the user and the second identity of the user to be cancelled. This may involve a certificate that is already stored in the distributed database 100 and assigns the first identity to the second identity being declared revoked or being deleted from the distributed database 100. The third transaction may, for example, be initiated by a user of the distributed database 100 that is categorized as trusted (e.g., by the aforementioned CA node 250).

FIG. 4 shows a flowchart to illustrate a method that may be used to implement the depicted concepts in the CA node 250 and/or RA node 260 of the distributed database system 200. The method may be implemented, for example, by virtue of program code stored in a memory of the CA node 250 or RA node 260 being executed by one or more processors 251 of the CA node 250 or one or more processors 261 of the RA node 260.

In block 410, for a user of the distributed database 100 that has a first identity, a second identity is examined. This may involve, for example, the CA node 250 using the distributed database 100 to interact with the RA node 260 in order to receive a confirmation of the authenticity or legality of the second identity from the RA node 260. For example, the RA node 260 may initiate a transaction in the distributed database 100 that confirms the authenticity or legality of the second identity of the user. The CA node may then initiate a transaction that links the first identity to the second identity. Alternatively, however, it would also be possible for the CA node 250 to interact with the RA node 260 without the involvement of the distributed database 100 (e.g., by virtue of the CA node 250 transmitting a request to the RA node 260, whereupon the RA node 260 confirms or does not confirm the authenticity or legality of the second identity with a response to the CA node 250).

The first identity is a public cryptographic key of the user that is able to be used for signing transactions in the distributed database. The transaction data of such transactions may include the public cryptographic key, a hash value of the public cryptographic key, and/or another identifier of the public cryptographic key.

In block 420, the CA node 250 assigned to a user of the distributed database 100 that is categorized as trusted initiates a transaction in the distributed database 100. The transaction links the first identity of the user to the second identity of the user. This may involve, for example, an applicable certificate that assigns the first identity to the second identity being stored in the distributed database 100.

The functions of blocks 410 and 420 may also be standardized in a transaction that may be initiated, for example, by the CA node or the RA node 260. The user may be identifiable outside the distributed database by the second identity. An anonymous or pseudonymous nature of the first identity may therefore be cancelled by the linking. The second identity may include, for example, one or more pieces of information that identify the user as a natural person, a legal person, an organization, a machine, or a physical object. Such information may include, for example, a name (e.g., a personal name, an organization name, a device name, a product name, or a manufacturer name). Additionally, such information may also include other identification information (e.g., a product number) or address data.

In block 430, a further transaction may optionally be initiated in the distributed database 100 that cancels the linking of the first identity of the user to the second identity of the user. This may involve, for example, the CA node 250 declaring an applicable certificate that assigns the first identity to the second identity revoked or deleting the certificate from the distributed database 100.

The depicted concepts may therefore involve a linking of two identities of a user of the distributed database 100 being realized via the distributed database 100 itself without, for example, a dedicated PKI infrastructure being required. However, it is possible to use the RA of an existing PKI system, which may simplify implementation or integration in existing systems. Ultimately, the effect that may be achieved is that certified or authenticated identities are available in the distributed database 100 for parties to a transaction. The linking of the first identity with the second identity may be realized by the distributed database 100 in a simple and manipulation-proof manner. Additionally, good verifiability and traceability of any changes in such a linking may be achieved. A program code (e.g., smart contract program code) used for implementation may be created with little outlay and low complexity, which also allows simplified checkability of the program code. An implementation using program code that is itself stored in the distributed database 100 (e.g., as a smart contract program code) also allows simple updatability of the program code to be achieved.

The preceding examples permit numerous modifications. As such, besides an implementation of the distributed database 100 as blockchain, various other implementations are also possible (e.g., as a “distributed ledger”, which is not based on a linear block structure). Additionally, various types of apparatuses or systems may be used in order to implement the nodes 210, 250 of the distributed database system 200.

Unless indicated otherwise in the description above, the terms “perform”, “calculate”, “computer-aided”, “compute”, “find”, “generate”, “configure”, “reconstruct”, “control”, “assign”, and the like may relate to actions and/or processes and/or processing acts that alter and/or generate data and/or that convert data into other data. The data is able to be presented or available as physical variables (e.g., as electrical impulses). For example, the expression “computer” or “apparatus” should be interpreted as broadly as possible in order to cover, for example, all electronic devices having data processing properties. Computers may therefore be, for example, personal computers, servers, programmable logic controllers (PLCs), handheld computer systems, pocket PC devices, mobile radios, and other communication devices that may process data in computer-aided fashion, processors, and other electronic devices for data processing.

Within the context of the present disclosure, “computer-aided” may be, for example, an implementation of the method in which, for example, a processor carries out at least one method act of the method.

Within the context of the present disclosure, a “processor” may, for example, a machine or an electronic circuit. A processor may be, for example, a central processing unit (CPU), a microprocessor or a microcontroller (e.g., an application-specific integrated circuit or a digital signal processor), possibly in combination with a memory unit for storing program instructions, etc. A processor may, for example, also be an integrated circuit (IC) (e.g., a field programmable gate array an (FPGA)), an application-specific integrated circuit (ASIC), a digital signal processor (DSP), or a graphics processor (e.g., a graphic processing unit (GPU)). A processor may also be a virtualized processor, a virtual machine, or a soft CPU. It may, for example, also be a programmable processor that is equipped with configuration acts for carrying out a method disclosed herein or that is configured by configuration acts such that the programmable processor realizes the disclosed features of methods, components, modules, or other aspects and/or subaspects of the present disclosure.

Within the context of the present disclosure, a “memory unit” or a “memory module” or the like may be, for example, a volatile memory in the form of random access memory (RAM) or a permanent memory such as a hard disk or a data medium.

Within the context of the present disclosure, “providing” (e.g., with reference to data and/or information) may be, for example, computer-aided providing. The providing is effected, for example, via a data interface (e.g., a database interface, a network interface, an interface to a memory unit). This interface may be used to communicate and/or transmit and/or retrieve and/or receive applicable data and/or information during the providing, for example.

Within the context of the present disclosure, “providing” may also be, for example, loading or storing (e.g., a transaction containing applicable data). This may be effected on or by a memory module, for example. “Providing” may also be, for example, transferring, transmitting, or communicating applicable data from one node to another node of the distributed database system.

Within the context of the present disclosure, “smart contract process” may be, for example, an execution of a program code (e.g., of the control commands) in a process by the distributed database, or the infrastructure thereof.

Within the context of the present disclosure, a “checksum” (e.g., a data block checksum, a data checksum, a node checksum, a transaction checksum, a concatenation checksum, or the like) may be, for example, a cryptographic checksum or cryptographic hash or hash value that is formed or calculated, for example, by a cryptographic hash function over a data record and/or data and/or one or more of the transactions and/or a subregion of a data block (e.g., the block header of a block of a blockchain or data block header of a data block of the distributed database or just some of the transactions of a data block). A checksum may be, for example, a checksum (e.g., checksums) or hash value (e.g., hash values) of a hash tree (e.g., Merkle tree, Patricia tree). Additionally, the checksum may, for example, also be a digital signature or a cryptographic message authentication code. The checksums may be used, for example, on different levels of the distributed database to provide cryptographic protection/protection against manipulation for the transactions and the data (e.g., records) stored therein. If, for example, a high level of security is called for, the checksums are produced and checked at transaction level, for example. If a lower level of security is called for, the checksums are produced and checked at block level (e.g., over the entire data block or only over part of the data block and/or some of the transactions), for example.

Within the context of the present disclosure, a “data block checksum” may be a checksum that, for example, is calculated over some or all transactions of a data block. A node may then, for example, examine/find the integrity/authenticity of the applicable part of a data block using the data block checksum. Additionally or alternatively, the data block checksum may, for example, also have been formed over transactions of a preceding data block/precursor data block of the data block. The data block checksum may, for example, also be realized by a hash tree (e.g., a Merkle tree, see Andreas M. Antonopoulos, “Mastering Bitcoin: Unlocking Digital Cryptocurrencies,” O'Reilly Media, December 2014, or a Patricia tree), where the data block checksum is, for example, the root checksum of the Merkle tree, of a Patricia tree, or of a binary hash tree. For example, transactions are safeguarded by further checksums from the Merkle tree or Patricia tree (e.g., using the transaction checksums), where, for example, the further checksums are leaves in the Merkle tree or Patricia tree. The data block checksum may thus, for example, safeguard the transactions by virtue of the root checksum being formed from the further checksums. The data block checksum may, for example, be calculated for transactions of a specific data block of the data blocks. For example, such a data block checksum may influence a succeeding data block of the specific data block in order to concatenate this succeeding data block to preceding data blocks, for example, and, for example, thus to make an integrity of the distributed database examinable. This allows the data block checksum to take over the function of the concatenation checksum, for example, or to influence the concatenation checksum. The header of a data block (e.g., of a new data block or of the data block for which the data block checksum was formed) may include the data block checksum, for example.

Within the context of the present disclosure, “transaction checksum” may be a checksum that is formed, for example, over a transaction of a data block. In addition, for example, a calculation of a data block checksum for an applicable data block may be speeded up, since, for example, already calculated transaction checksums may immediately be used as leaves (e.g., of a Merkle tree) for this.

Within the context of the present disclosure, a “concatenation checksum” may be a checksum that, for example, indicates or references a respective data block of the distributed database or the preceding data block of the distributed database (e.g., frequently referred to as “previous block hash” in the technical literature). This involves, for example, an applicable concatenation checksum being formed for the applicable preceding data block. The concatenation checksum used may be, for example, a transaction checksum or the data block checksum of a data block (e.g., a present data block of the distributed database) in order to concatenate a new data block to a data block (e.g., a present data block) of the distributed database. It is, for example, alternatively possible for a checksum to be formed over a header of the preceding data block or over the entire preceding data block and to be used as concatenation checksum. This may also be calculated for multiple or all preceding data blocks, for example. It is, for example, also feasible for the concatenation checksum to be formed over the header of a data block and the data block checksum. However, a respective data block of the distributed database may include, in each case, a concatenation checksum that was calculated for, or relates to, a preceding data block (e.g., the directly preceding data block) of the respective data block. It is, for example, also possible for an applicable concatenation checksum also to be formed only over a portion of the applicable data block (e.g., preceding data block). This allows, for example, a data block that includes an integrity-protected portion and an unprotected portion to be realized. It would thus be possible, for example, for a data block having an integrity-protected portion that is invariable and having an unprotected portion that may still be altered later to be realized. In this context, integrity-protected may be, for example, that an alteration of integrity-protected data is detectable by a checksum.

The data that is stored in a transaction of a data block, for example, may be provided, for example, in various ways. Instead of the data (e.g., user data such as measurement data or data/ownership concerning assets), for example, a transaction of a data block may include only the checksum for this data. In this case, the applicable checksum may be realized in various ways. This may be, for example, an applicable data block checksum of a data block (e.g., with the applicable data) of another database or of the distributed database system, a transaction checksum of a data block with the applicable data (e.g., of the distributed database or of another database), or a data checksum that was formed over the data.

In addition, the applicable transaction may also include a reference or an indication concerning a storage location (e.g., an address of a file server and indications of where the applicable data may be found on the file server; or an address of another distributed database including the data). The applicable data may then, for example, also be provided in a further transaction of a further data block of the distributed database (e.g., if the applicable data and the associated checksums are included in different data blocks). However, it is also conceivable, for example, for this data to be provided via another communication channel (e.g., via another database and/or a cryptographically secure communication channel).

In addition to the checksum, for example, it is also possible for an additional data record (e.g., a reference or an indication concerning a storage location) to be stored in the applicable transactions, which indicates, for example, a storage location where the data may be retrieved. This is advantageous, for example, to minimize a data size of the distributed database.

Within the context of the present disclosure, “security” may be, for example, protection of data that is realized, for example, by a cryptographic method. By way of example, this may be realized by virtue of use of the distributed database for providing, transferring, or transmitting applicable data/transactions. This may be achieved by a combination of the different checksums (e.g., cryptographic checksums) by virtue of the different checksums interacting synergistically (e.g., in order to improve the security or the cryptographic security for the data of the transactions). In other words, within the context of the present embodiments, “security-protected” may, for example, also be “cryptographically protected” and/or “manipulation-protected”, where “manipulation-protected” may also be referred to as “integrity-protected”.

Within the context of the present disclosure, “concatenating data blocks” may be, for example, that data blocks each include information (e.g., concatenation checksum) that refers to, or references, one other data block or multiple other data blocks of the distributed database (see: Andreas M. Antonopoulos, “Mastering Bitcoin: Unlocking Digital Cryptocurrencies,” O'Reilly Media, December 2014; Henning Diedrich, “Ethereum: Blockchains, Digital Assets, Smart Contracts, Decentralized Autonomous Organizations,” CreateSpace Independent Publishing Platform, 2016; and Leemon Baird, “The Swirlds Hashgraph Consensus Algorithm: Fair, Fast, Byzantine Fault Tolerance,” Swirlds Tech Report SWIRLDS-TR-2016-01, May 31, 2016).

Within the context of the present disclosure, “inserting into the distributed database”, “storing data in the distributed database”, “storing in the distributed database” or the like may be, for example, that a transaction or the transactions or a data block with corresponding transactions is/are communicated to one or more nodes of a distributed database system. If these transactions are validated successfully (e.g., by the node(s)), for example, these transactions are concatenated, for example, as a new data block with at least one present data block of the distributed database (see: Andreas M. Antonopoulos, “Mastering Bitcoin: Unlocking Digital Cryptocurrencies,” O'Reilly Media, December 2014; Henning Diedrich, “Ethereum: Blockchains, Digital Assets, Smart Contracts, Decentralized Autonomous Organizations,” CreateSpace Independent Publishing Platform, 2016; and Leemon Baird, “The Swirlds Hashgraph Consensus Algorithm: Fair, Fast, Byzantine Fault Tolerance,” Swirlds Tech Report SWIRLDS-TR-2016-01, May 31, 2016). For this purpose, the applicable transactions are stored in a new data block, for example. For example, this validating and/or concatenating may be effected by a trusted node (e.g., a mining node, a blockchain oracle, or a blockchain platform). For example, a blockchain platform may be a blockchain as service, as proposed by Microsoft or IBM, for example. For example, a trusted node and/or a node may in each case store a node checksum (e.g., a digital signature) in a data block (e.g., in the data block generated and validated, which is then concatenated) in order, for example, to enable an identifiability of the creator of the data block and/or to enable an identifiability of the node. This node checksum indicates which node has concatenated, for example, the applicable data block with at least one other data block of the distributed database.

Within the context of the present disclosure, “transaction” or “transactions” may be, for example, a smart contract (see: Henning Diedrich, “Ethereum: Blockchains, Digital Assets, Smart Contracts, Decentralized Autonomous Organizations,” CreateSpace Independent Publishing Platform, 2016; and Leemon Baird, “The Swirlds Hashgraph Consensus Algorithm: Fair, Fast, Byzantine Fault Tolerance,” Swirlds Tech Report SWIRLDS-TR-2016-01, May 31, 2016), a data structure, or a transaction data record that includes, for example, in each case one of the transactions or multiple transactions. Within the context of the present embodiments, “transaction” or “transactions” may, for example, also be the data of a transaction of a data block of a blockchain. A transaction may include, for example, a program code that realizes a smart contract, for example. By way of example, within the context of the present embodiments, transaction may also be a control transaction and/or confirmation transaction. Alternatively, a transaction may be, for example, a data structure that stores data (e.g., control commands and/or contract data and/or other data such as video data, user data, measurement data, etc.).

“Storing transactions in data blocks”, “storing transactions”, and the like may be direct storing or indirect storing. Direct storing may be, for example, that the applicable data block or the applicable transaction includes the respective data. Indirect storing may be, for example, that the applicable data block or the applicable transaction includes a checksum and optionally an additional data record (e.g., a reference or an indication concerning a storage location) for applicable data, and, consequently, the applicable data are not stored directly in the data block or the transaction (e.g., instead only a checksum for these data). For example, when storing transactions in data blocks, it is possible to validate these checksums, for example, as explained, for example, under “inserting into the distributed database system”.

Within the context of the present disclosure, a “program code” (e.g., a smart contract) may be, for example, one program instruction or multiple program instructions that are stored, for example, in one or more transactions. The program code is executable, for example, and is executed by the distributed database system, for example. This may be realized by an execution environment (e.g., of a virtual machine), for example, where the underlying programming language may be Turing complete. The program code may be executed by the infrastructure of the distributed database system (see: Henning Diedrich, “Ethereum: Blockchains, Digital Assets, Smart Contracts, Decentralized Autonomous Organizations,” CreateSpace Independent Publishing Platform, 2016; and “The Ethereum Book Project/Mastering Ethereum” https://github.com/ethereumbook/ethereumbook, version as at Oct. 5, 2017). In this case, for example, a virtual machine is realized by the infrastructure of the distributed database system.

Within the context of the present disclosure, a “smart contract” may be, for example, an executable program code (see: Henning Diedrich, “Ethereum: Blockchains, Digital Assets, Smart Contracts, Decentralized Autonomous Organizations,” CreateSpace Independent Publishing Platform, 2016; and “The Ethereum Book Project/Mastering Ethereum” https://github.com/ethereumbook/ethereumbook, version as at Oct. 5, 2017) (see, for example, the definition of “program code”). The smart contract may be stored in a transaction of a distributed database (e.g., a blockchain), such as, for example, in a data block of the distributed database. By way of example, the smart contract may be executed in the same way as explained in the definition of “program code” (e.g., within the context of the present embodiments).

Within the context of the present disclosure, “proof-of-work verification” may be, for example, solving a computationally intensive task that is to be solved, for example, depending on the data block content/content of a specific transaction (see: Andreas M. Antonopoulos, “Mastering Bitcoin: Unlocking Digital Cryptocurrencies,” O'Reilly Media, December 2014; Henning Diedrich, “Ethereum: Blockchains, Digital Assets, Smart Contracts, Decentralized Autonomous Organizations,” CreateSpace Independent Publishing Platform, 2016; and “The Ethereum Book Project/Mastering Ethereum” https://github.com/ethereumbook/ethereumbook, version as at Oct. 5, 2017). Such a computationally intensive task is, for example, also referred to as a cryptographic puzzle.

In the context of the present disclosure, a “distributed database” may be, for example, a decentralized distributed database, a blockchain, a distributed ledger, a distributed storage system, a distributed ledger technology (DLT) based system (DLTS), an audit-proof database system, a cloud, a cloud service, a blockchain in a cloud, or a peer-to-peer database. It is also possible to use, for example, various implementations of a blockchain or a DLTS, such as, for example, a blockchain or a DLTS implemented by a directed acyclic graph (DAG), a cryptographic puzzle, a Hashgraph, or a combination of the implementation variants mentioned (see: Leemon Baird, “The Swirlds Hashgraph Consensus Algorithm: Fair, Fast, Byzantine Fault Tolerance,” Swirlds Tech Report SWIRLDS-TR-2016-01, May 31, 2016; and Leemon Baird, “Overview of Swirlds Hashgraph,” May 31, 2016). It is also possible for various consensus methods (e.g., consensus algorithms) to be implemented, for example. This may be, for example, a consensus method using a cryptographic puzzle, gossip about gossip, virtual voting, or a combination of the methods mentioned (e.g., gossip about gossip combined with virtual voting) (see: Leemon Baird, “The Swirlds Hashgraph Consensus Algorithm: Fair, Fast, Byzantine Fault Tolerance,” Swirlds Tech Report SWIRLDS-TR-2016-01, May 31, 2016; and Leemon Baird, “Overview of Swirlds Hashgraph,” May 31, 2016). If a blockchain is used, for example, then this may be implemented, for example, by a Bitcoin-based realization or an Ethereum-based realization (see: Andreas M. Antonopoulos, “Mastering Bitcoin: Unlocking Digital Cryptocurrencies,” O'Reilly Media, December 2014; Henning Diedrich, “Ethereum: Blockchains, Digital Assets, Smart Contracts, Decentralized Autonomous Organizations,” CreateSpace Independent Publishing Platform, 2016; and Leemon Baird, “The Swirlds Hashgraph Consensus Algorithm: Fair, Fast, Byzantine Fault Tolerance,” Swirlds Tech Report SWIRLDS-TR-2016-01, May 31, 2016).

A “distributed database system” may be a system for implementing a distributed database or the infrastructure thereof. A “distributed database system” of this kind may, for example, also be a distributed database system of which at least some of its nodes, devices, and/or infrastructure are realized by a cloud. By way of example, the applicable components may be realized as virtual components in the cloud (e.g., as a virtual node or a virtual machine). This may be effected, for example, by VM-Ware, Amazon Web Services or Microsoft Azure. On account of the high flexibility of the implementation variants explained, for example, partial aspects of the implementation variants mentioned may also be combined with one another (e.g., by using a Hashgraph as a blockchain, where the blockchain itself may also be blockless).

If, for example, a directed acyclic graph (DAG) is used (e.g., IOTA or Tangle), for example, transactions or blocks or nodes of the graph are connected to one another via directed edges. Acyclic may be, for example, that there are no loops when moving through the graph. The directed edges and the acyclicity may provide that the chronological order of many transactions is clearly established.

The distributed database may be, for example, a public distributed database (e.g., a public blockchain) or a closed or private distributed database (e.g., a private blockchain).

If a public distributed database is involved, for example, this provides that new nodes and/or devices may join the distributed database system or be accepted by the distributed database system without authorization verifications, without authentication, without log-on information, or without credentials. For example, the operators of the nodes and/or devices may initially remain anonymous in such a case.

If the distributed database is a closed distributed database, for example, new nodes and/or devices require, for example, a valid authorization verification and/or valid authentication information and/or valid credentials and/or valid log-on information in order to be able to join the distributed database system or in order to be accepted by the distributed database system.

The distributed database system may also be, for example, a distributed communication system for data interchange. This may be, for example, a network or a peer-2-peer network.

Within the context of the present disclosure, a “data block”, which may also be referred to as “link” or “block”, for example, depending on context and realization, may be, for example, a data block in a distributed database that, for example, is realized as a data structure and may include, in each case, one of the transactions or multiple instances of the transactions. In one implementation, for example, the distributed database or the database system may be a DLTS or a blockchain, and a data block may be a block of the blockchain or of the DLTS. A data block may include, for example, indications concerning the size (e.g., data size in bytes) of the data block, a data block header, a transaction counter, and one or more transactions (see: Andreas M. Antonopoulos, “Mastering Bitcoin: Unlocking Digital Cryptocurrencies,” O'Reilly Media, December 2014). The data block header may include, for example, a version, a concatenation checksum, a data block checksum, a time stamp, a proof-of-work verification, and a nonce (e.g., one-off value, random value, or counter used for the proof-of-work verification) (see: Andreas M. Antonopoulos, “Mastering Bitcoin: Unlocking Digital Cryptocurrencies,” O'Reilly Media, December 2014; Henning Diedrich, “Ethereum: Blockchains, Digital Assets, Smart Contracts, Decentralized Autonomous Organizations,” CreateSpace Independent Publishing Platform, 2016; and Leemon Baird, “The Swirlds Hashgraph Consensus Algorithm: Fair, Fast, Byzantine Fault Tolerance,” Swirlds Tech Report SWIRLDS-TR-2016-01, May 31, 2016). A data block may, for example, also be only a specific storage area or address area of the entire data stored in the distributed database. It is thus possible to realize, for example, blockless distributed databases, such as, for example, the IOT chain (ITC), IOTA, and Byteball. In this case, for example, the functionalities of the blocks of a blockchain and of the transactions are combined with one another such that, for example, the transactions themselves safeguard the sequence or chain of transactions of the distributed database (e.g., are stored in a security-protected manner). For this purpose, with a concatenation checksum, for example, the transactions themselves may be concatenated with one another (e.g., by virtue of a separate checksum or the transaction checksum of one or more transactions serving as concatenation checksum), which is concomitantly stored in the applicable new transaction when a new transaction is stored in the distributed database. In such an embodiment, a data block may, for example, also include one or more transactions, where, in the simplest case, for example, a data block corresponds to a transaction.

Within the context of the present disclosure, “nonce” may be, for example, a cryptographic nonce (abbreviation of: “used only once”, see Roger M. Needham, Michael D. Schroeder, “Using encryption for authentication in large networks of computers,” ACM: Communications of the ACM, Volume 21, No. 12 Dec. 1978, or “number used once”, see Ross Anderson, “Security Engineering. A Guide to Building Dependable Distributed Systems,” Wiley, 2001). For example, a nonce denotes an individual combination of numbers or letters that may be used once in the respective context (e.g., transaction, data transfer).

Within the context of the present embodiments, “data blocks preceding a (specific) data block” may be, for example, that data block of the distributed database that directly precedes, for example, a specific data block. Alternatively, “data blocks preceding a (specific) data block” may, for example, also be all data blocks of the distributed database that precede the specific data block. Such preceding data blocks may also be referred to as a “predecessor data block”. As a result, by way of example, the concatenation checksum or the transaction checksum may be formed, for example, only over the data block or the transactions thereof directly preceding the specific data block or over all data blocks or the transactions thereof preceding the first data block.

Within the context of the present disclosure, a “node” may be, for example, devices (e.g., field devices, mobile phones), computers, personal computers, smartphones, clients, or subscriber devices that perform operations with the distributed database or in the distributed database (see: Andreas M. Antonopoulos, “Mastering Bitcoin: Unlocking Digital Cryptocurrencies,” O'Reilly Media, December 2014; Henning Diedrich, “Ethereum: Blockchains, Digital Assets, Smart Contracts, Decentralized Autonomous Organizations,” CreateSpace Independent Publishing Platform, 2016; and Leemon Baird, “The Swirlds Hashgraph Consensus Algorithm: Fair, Fast, Byzantine Fault Tolerance,” Swirlds Tech Report SWIRLDS-TR-2016-01, May 31, 2016). Such nodes may, for example, execute transactions of the distributed database or the data blocks thereof or insert or concatenate new data blocks with new transactions into the distributed database. For example, this validating and/or concatenating may be effected by a trusted node (e.g., a mining node) or exclusively by trusted nodes. A trusted node is, for example, a node that has additional security measures (e.g., firewalls, access restrictions to the node, or the like) in order to prevent a manipulation of the node. Alternatively or additionally, by way of example, during the concatenating of a new data block with the distributed database, a trusted node may store a node checksum (e.g., a digital signature or a certificate) in the new data block. A verification may thus be provided, for example, that indicates that the applicable data block was inserted by a specific node, or indicates a corresponding origin. A node typically includes at least one processor (e.g., in order to carry out corresponding functions in computer-aided or computer-implemented fashion).

Within the context of the present disclosure, a “blockchain oracle” may be, for example, nodes, devices, or computers that have, for example, a security module including, for example, software protection mechanisms (e.g., cryptographic methods), mechanical protection devices (e.g., a lockable housing), or electrical protection devices (e.g., tamper protection or a protection system that erases the data of the security module in the event of impermissible use/handling of the blockchain oracle). The security module may include cryptographic keys, for example, that are required for calculating the checksums (e.g., transaction checksums or node checksums).

Within the context of the present disclosure, an “apparatus” may be, for example, a computer (e.g., computer system), a client, a smartphone, a server, or a similar device. Such an apparatus may be arranged outside the distributed database system, or may not be a subscriber of the distributed database (e.g., the blockchain; does not itself perform operations in the distributed database and only queries the distributed database, but without performing transactions, inserting data blocks, or calculating proof-of-work verifications). Alternatively, such an apparatus may also implement a node of the distributed database system. In other words, an apparatus may, for example, be a node of the distributed database system or an apparatus outside the distributed database system. An apparatus outside the distributed database system may, for example, access the data (e.g., transactions) of the distributed database and/or be driven by nodes (e.g., by a smart contract and/or blockchain oracle). If, for example, driving or control of an apparatus outside the distributed database system is realized by a node of the distributed database system, this may be effected, for example, by a smart contract stored, for example, in a transaction of the distributed database.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An apparatus for providing a distributed database, the apparatus comprising:
a processor configured to:
store, for a user of the distributed database that has a first identity, transaction data of a transaction in the distributed database,
wherein the first identity comprises a public cryptographic key that is usable for signing a transaction in the distributed database, and
wherein the transaction links the first identity to a second identity.

2. The apparatus of claim 1, wherein the processor is further configured to:
store transaction data of at least one further transaction in the distributed database,
wherein the at least one further transaction cancels the linking of the first identity of the user to the second identity.

3. The apparatus of claim 2, wherein the at least one further transaction is initiable exclusively by one or more users of the distributed database that are categorized as trusted.

4. An apparatus for providing a distributed database, the apparatus comprising:
a processor configured to:
examine, for a user of the distributed database that has a first identity, a second identity; and
initiate a transaction in the distributed database that links the first identity to the second identity of the user,
wherein the first identity comprises a public cryptographic key that is usable for signing a transaction in the distributed database.

5. The apparatus of claim 4, wherein the processor is further configured to:
initiate a further transaction in the distributed database,
wherein the further transaction cancels the linking of the first identity to the second identity.

6. The apparatus as of claim 5, wherein the further transaction is initiable exclusively by one or more users of the distributed database that are categorized as trusted.

7. The apparatus of claim 1, wherein the user is identifiable outside the distributed database using the second identity.

8. The apparatus of claim 1, wherein the second identity comprises one or more pieces of information that identify the user as a natural person, a legal person, an organization, a machine or a physical object.

9. The apparatus of claim 1, wherein the transaction for linking the first identity and the second identity is initiable exclusively by one or more users of the distributed database that are categorized as trusted.

10. A method, comprising:
storing, for a user of a distributed database that has a first identity, transaction data of a transaction in the distributed database,
wherein the first identity comprises a public cryptographic key that is usable for signing a transaction in the distributed database, and
wherein the transaction links the first identity to a second identity.

11. The method of claim 10, further comprising:
storing transaction data of at least one further transaction in the distributed database,
wherein the further transaction cancels the linking of the first identity to the second identity.

12. A method, comprising:
examining, for a user of a distributed database that has a first identity, a second identity; and
initiating a transaction in the distributed database that links the first identity to the second identity,
wherein the first identity comprises a public cryptographic key that is usable for signing a transaction in the distributed database.

13. The method of claim 12, further comprising:
initiating a further transaction in the distributed database,
wherein the further transaction cancels the linking of the first identity to the second identity.

14. In a non-transitory computer-readable storage medium that stores instructions executable, by one or more processors of a programmable apparatus, the instructions comprising:
storing, for a user of a distributed database that has a first identity, transaction data of a transaction in the distributed database,
wherein the first identity comprises a public cryptographic key that is usable for signing a transaction in the distributed database, and
wherein the transaction links the first identity to a second identity.

15. The non-transitory computer-readable storage medium of claim 14, wherein the instructions further comprise:
storing transaction data of at least one further transaction in the distributed database,
wherein the further transaction cancels the linking of the first identity to the second identity.
